(19) United States
(12) Patent Application Publication
(10) Pub. No.: US 2023/0065513 A1
(43) Pub. Date: Mar. 2, 2023

(54) PLATFORM SCREEN DOOR INSTALLATION SYSTEM

(71) Applicant: KNORR-BREMSE RAIL SYSTEM (UK) LTD, Melksham, Wiltshire (GB)

(72) Inventor: Stewart Milton, Calne, Wiltshire (GB)

(21) Appl. No.: 17/794,448

(22) PCT Filed: Jan. 22, 2021
(86) PCT No.: PCT/EP2021/051526

§ 371 Date: Jul. 21, 2022

(30) Foreign Application Priority Data
Jan. 22, 2020 (GB) 2000931.2

(51) Int. Cl. B61D 3/04; B61D 3/16

(52) U.S. Cl. CPC B61D 3/04; B61D 3/16; B61B 1/02

(57) ABSTRACT

A trailer vehicle having a stillage for one or more platform screen door module, wherein a respective first and second lifting module is provided at the respective front and rear end of the trailer vehicle, wherein the lifting module comprises a support bed and post for the platform screen door module, which is configured to laterally translate the or each platform screen door module and is provided with a tilt mechanism The tilt mechanism allows the support post to tilt around 20 degrees forwards and 10 degrees backwards from a plane vertical with respect to the trailer to compensate for positive and negative camber of the tracks.

The invention relates to a platform screen door system and in particular to the installation system for a platform screen door system.

The conventional railway station consisting of a raised platform adjacent to the track is essentially the same design as has been used since the beginning of the railway industry in the nineteenth century and is an effective solution to the problem of maximising passenger boarding speed.

However, the basic platform arrangement suffers from several well-known problems, such as passengers falling under trains either deliberately or unintentionally and also litter from passengers falling onto the track. Although incidents of people falling under trains are not common, they result in significant disruption to the network and are traumatic incidents for everyone present. The problem of litter on the track has also increased in recent years and can represent a serious health and safety risk on underground or sub-surface systems where the litter will remain in tunnels until it is cleared up.

Platform screen door systems or automated platform gates are well known in the railway industry as one approach of dealing with these problems. Due to the problem of lining up doors on the platform and the train, these systems are usually only installed on lines where the rolling stock is standardised, which in practice is on metro or underground systems, although some dedicated high-speed systems are also provided with screens.

One of the problems preventing a more widespread adoption of platform screen doors has been the relatively high installation costs. As each panel, often weighing 100 kg, needs to be transported to the platform and installed there, the known platform screen door systems are generally bespoke and constructed in situ.

CN203666645U discloses a modular platform screen system in which the modular sliding door unit structure comprises steel frame components, a top box, a transmission mechanism, a sliding door leaf and a threshold. The threshold is located on the lower side of the sliding door leaf. The steel frame components are fixed to the two sides of the threshold and perpendicular to the threshold. The top box is located above the sliding door leaf and fixed between the two steel frame components. The transmission mechanism is installed in the top box and fixedly connected with the steel frame components on the two sides. This document however suffers from the common problem of modular construction, namely that the pre-fabricated units are large and heavy and so difficult and expensive to transport to the installation site. The document does not provide any disclosure in this regard and it is not known to have been used in practice

The present invention therefore seeks to provide an improved modular platform screen system that addresses these problems.

According to the invention there is provided a trailer vehicle having a stillage for one or more platform screen door module, wherein a respective first and second lifting module is provided at the respective front and rear end of the trailer vehicle, wherein the lifting module is configured to laterally translate the or each platform screen door module and is provided with a tilt mechanism, which tilt mechanism can tilt the or each platform screen module.

Preferred aspects of the invention can be found in the sub-claims

An exemplary embodiment of the invention will now be described in greater detail with reference to the drawings in which:

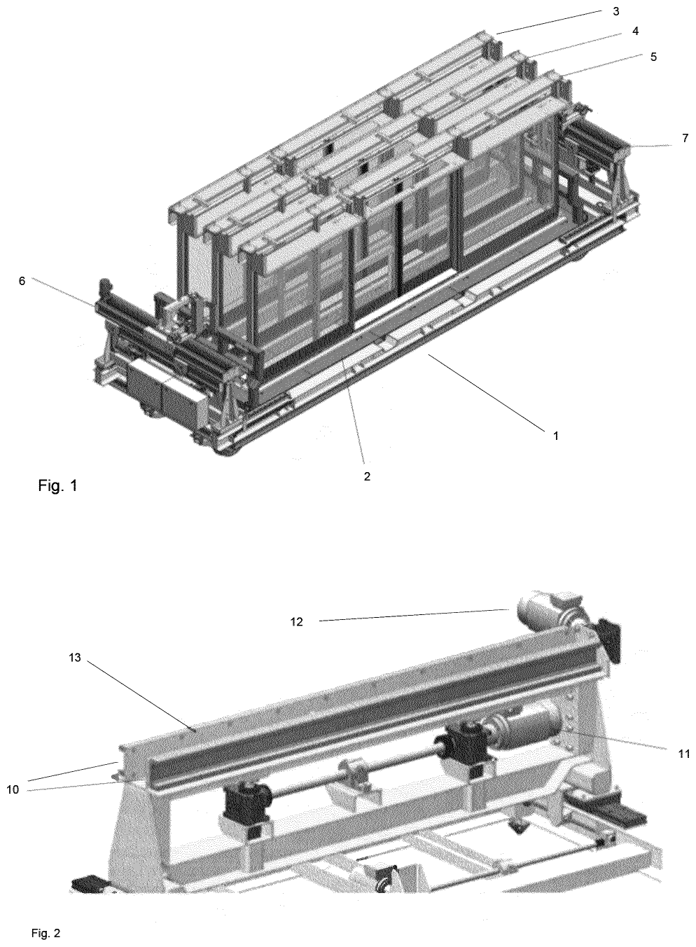

FIG. 1 shows a perspective view of a platform door transport

FIG. 2 shows a raise lower mechanism

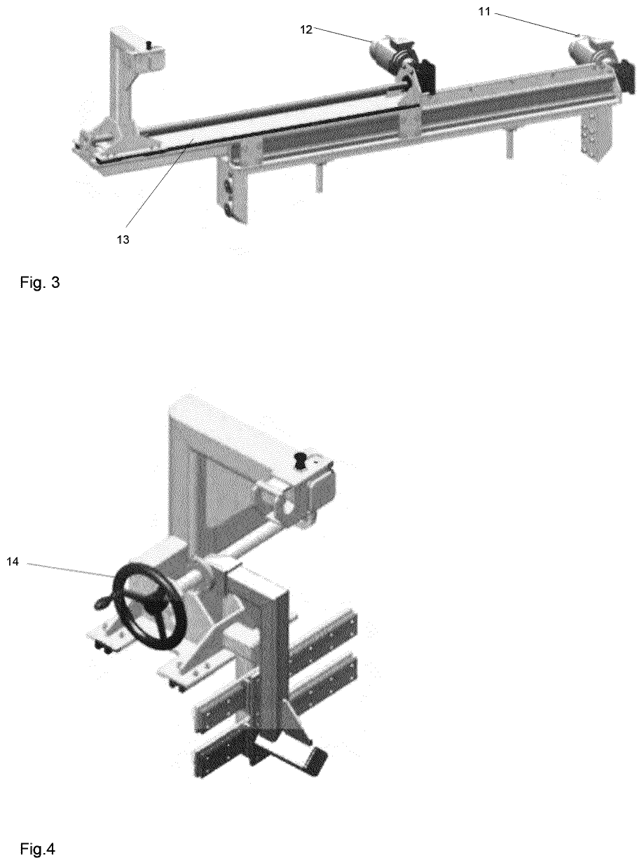

FIG. 3 shows a linear transverse mechanism

FIG. 4 shows a tilt mechanism

FIG. 1 shows a perspective view of a platform door transport comprising a trailer vehicle 1 having a stillage 2 for receiving three platform screen door modules 3,4,5. A respective first 6 and second 7 lifting module is provided at the respective front and rear end of the trailer vehicle 1 with respect to its direction of longitudinal travel. A twist lock interface is provided at each end of the platform screen door to retain the platform screen door modules in position during transit.

The first and second lifting modules 6,7 each comprise a screw jack assembly that is driven by a respective electric motor under the control of control electronics. Limit switches and an emergency stop are provided.

The raise lower mechanism shown in FIG. 2 comprises a linear roller bearing arrangement 10. This enables the raise lower carriage to remain slim and in close proximity to the platform screen door module. The linear roller bearings also provide rigid support for the off-set load applied to them. The raise/lower motions are driven by screw jacks 11, 12, enabling accurate positioning and holding of a set position.

The sliding guide bed 13 is positioned above the screws instead of to one side, which reduces the off-set loading applied.

FIG. 3 shows a linear transverse mechanism. The linear transverse mechanism comprises a screw jack driven coupling trolley arranged to travel front to back on a support bed. This can then meet all three module locations on the stillage. A second motion delivers the coupling trolley to the platform edge for unloading. This motion is provided by driving the whole bed 13 forward complete with screw jack 11, using a further screw jack 12. The bed travels on four linear roller bearings running in profiled channels in the horizontal plane. The radial load capabilities of the bearings will easily be able to handle the off-set load.

FIG. 4 shows the tilt mechanism in further detail. The tilt mechanism is incorporated into the coupling trolley. The tilt motion can be manually controlled, as the degree of tilt required is relatively low. The mechanism makes use of the off-set between the centre of gravity and the pivot point on the interface posts. The off-set means the module naturally wants to tilt, so a supporting post positioned on linear guide bearings provides support to the interface post and holds the module vertical. The support post is then attached to a rotating nut on a screw which can be hand wound 14. By winding the screw the position of the supporting post can be moved forward and back to allow the platform screen door module to tilt. The tilt mechanism allows the support post to tilt around 20 degrees forwards and 10 degrees backwards from the vertical plane. This compensates for positive and negative camber of the tracks at each platform where the platform screen doors are to be installed.

For the installation process, a works train can align the trailer vehicle to the appropriate Module location so that the platform screen door module is ready to be offloaded. An operator then selects the first lifting module control setting then using left/right commands and extend/retract commands, aligns the lifting mechanism ready to pick up the respective interface post of the platform screen door module. This is then repeated for the second lifting mechanism.

With both sides engaged the operator isolates the controls and detaches the platform screen door module from the stillage at both ends of the module. The module is then detached from the stillage. Using a combination of Raise, Extend and Traverse commands, the operator is able to lift the module clear of any obstructions on the stillage and drive it towards the platform edge.

The Traverse command enables the operator to compensate for misalignment of the platform screen door in relation to its installation position along the platform. If required, the module can be tilted to help clear any obstructions from above in its line of path. Tilt is achieved by a manual hand wind facing the platform at each end of the module and requires two operators turning their respective wheels at the same rate. A large ratio is used between the hand wind and screw motion to help prevent one side tilting significantly more than the other. With the nominal amount of module tilt in place, the extend motion to clear the obstacles and deliver the module to the platform edge can be continued.

Once any obstacles have been cleared, the operators will tilt the module back to vertical.

As the platforms vary along their length and from platform to platform, the operator can now switch to individual control of the Lifting mechanisms to fine position each end.

Some modules are required to locate around a vertical structural post at one end. This can be done using the traverse motion in dual control mode. Provision is made in the mounting method of the Interface posts to allow a clear path around a vertical structural post). The module can now be placed for fixing to the platform.

Once the module is anchored to the platform, the operator the locating pins of the Interface posts are removed and using individual control over each lifting mechanism; each lifting mechanism, is driven back to their home position with the interface posts still attached.

1. A trailer vehicle having a stillage for one or more platform screen door modules, wherein a respective first and second lifting module is provided at the respective front and rear end of the trailer vehicle, wherein the lifting module is configured to laterally translate the or each platform screen door module and is provided with a tilt mechanism, which tilt mechanism can tilt the or each platform screen module.

2. The trailer vehicle according to claim 1, wherein the or each lifting module comprises a raise lower mechanism, a linear transverse mechanism and a tilt mechanism.

3. The trailer vehicle according to claim 1, wherein the raise lower mechanism comprises a plurality of screw jacks to enable positioning and holding of a set position, wherein a sliding guide bed is positioned above the screw jacks.

4. The trailer vehicle according to claim 1, wherein the lifting module comprises a support post and bed for the platform screen door module, the tilt mechanism allowing the support post to tilt around 20 degrees forwards and 10 degrees backwards from a plane vertical with respect to the trailer to compensate for positive and negative camber of the tracks.

5. The trailer vehicle according to claim 1, wherein each lifting module comprises a screw jack assembly that is driven by a respective electric motor under the control of control electronics.

6. The trailer vehicle according to claim 1, wherein the lifting modules are controllable independently of one another.

7. The trailer vehicle according to claim 3, wherein the transverse mechanism is provided with a second screw jack adapted to drive the sliding guide bed and first screw jack in a second motion.

8. The trailer vehicle according to claim 3, wherein the sliding guide bed travels on four linear roller bearings running in profiled channels in the horizontal plane of the trailer vehicle.

9. The trailer vehicle according to claim 2, wherein the tilt mechanism is off-set between the centre of gravity and the pivot point on the interface posts.
